(19) United States
(12) Patent Application Publication
(10) Pub. No.: US 2023/0322118 A1
(43) Pub. Date: Oct. 12, 2023

(54) HIGH-POWER CHARGING SYSTEM FOR ELECTRIC VEHICLES WITH ENERGY STORAGE UNIT

(71) Applicant: Enel X Way S.r.l., Roma RM (IT)

(72) Inventors: Tiziano VALENTINETTI, Roma (IT); Mauro PALUMBO, Roma (IT); Eleonora SAMMARTINO, Roma (IT)

(21) Appl. No.: 18/025,132

(22) PCT Filed: Sep. 7, 2021
(86) PCT No.: PCT/IB2021/058133

§ 371 Date: Mar. 7, 2023

(30) Foreign Application Priority Data
Sep. 7, 2020 (IT) 102020000021118

(51) Int. Cl. B60L 53/66; B60L 53/62

(52) U.S. Cl. CPC B60L 53/665; B60L 53/62

(57) ABSTRACT

The present invention relates to a high-power charging system for electric vehicles with energy storage unit.

The present invention relates to a high-power charging system for electric vehicles with energy storage unit.

A high-power charging system for electric vehicles is defined as a direct current (DC) charging station that can supply a voltage of at least 200-1000 V, and a typical maximum current of 500 A, with powers greater than 150 kW.

### BACKGROUND

High-power charging systems for electric vehicles (HPC—High Power Charging) using an energy storage system (BESS—Battery Energy Storage System) are already known on the market.

In general, known architectures can be classified into two types, both consisting of the following parts:
Transformer MV/LV: medium voltage to low voltage transformer cabin;
Power Box Unit: device being part of the HPC which interfaces the charging system with the electricity grid and is responsible for converting the power to make it usable for charging the vehicle and/or the energy storage unit (BESS);
BESS: the unit containing the devices for energy storage, basically consisting of the control apparatus of the system for interfacing the Battery with the Bus and of the Battery Management System (BMS);
Dispenser Unit: is the energy dispensing unit and therefore the interface with the vehicle/user.

It should be noted that in this document, system architectures, and not specific hardware, software or circuit configurations, will be described. Therefore, reference will be made to general diagrams, exemplifying the architectures, without going into details of the implementation of each individual component, which is to be considered within the knowledge of the skilled technician.

A first type of architecture (Centralized) realizes a high-power charging system with the energy storage unit (BESS) installed upstream of the entire system.

In this case, the BESS may be installed both in series and parallel configuration with respect to the remaining sub-parts, although the series case is completely excluded from the discussion, as it is notoriously disadvantageous.

### BRIEF DESCRIPTION OF THE FIGURES

In the following of this description, reference will be made to the drawings shown in the attached figures, in which:

FIG. 1 is an exemplary diagram of a charging system according to the known technique, based on a centralized architecture;

FIGS. 2a and 2b are exemplary diagrams of charging systems according to the known technique, based on a combined architecture;

FIGS. 3 to 8 are exemplary block diagrams of embodiments of a charging system according to the present invention; and

FIG. 9 schematises the communication between the boards, which are preferably based on CAN bus.

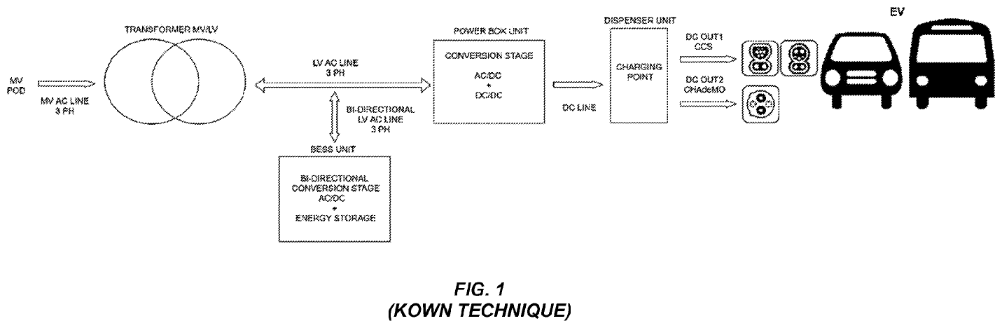

FIG. 1 shows an exemplary diagram of a centralized architecture system as described above.

Fundamentally, the stage unit is used to reduce grid connection costs (by exploiting the energy accumulated over time within the BESS to provide the power required at the time of recharging higher than that usable by the grid) and for the services for dispatching the network.

However, the Power Box Unit and the Dispenser Unit are to be designed from the outset in order to provide maximum power, without the possibility of being upgraded to provide greater power.

Therefore, a system which may not be suitable for recharging electric vehicles that will be present on the market in the near future is realized.

Furthermore, by adopting such configuration, sitting through service interruptions will be unavoidable. In fact, since the connection to the grid is less than the power deliverable by the station, the availability of the service cannot be independent of moments when the station will be off-line to compensate for the recharge of the energy storage system (BESS), thus causing a disservice and, above all, financial losses (lost revenue for recharges available during the time frame in which the system is offline). Furthermore, the series configuration of the BESS would cause a longer downtime, as not even the maximum usable power to the network would be deliverable from the station.

Furthermore, in terms of system efficiency, the BESS in this type of product/configuration involves an additional conversion stage, therefore higher losses and therefore higher operating costs.

Furthermore, any subsequent increases in power cause a retrofit of all the sub-parts of the charging station with related costs.

The second type of known architecture (Combined) instead provides the energy storage unit (BESS) to be interposed between the first AC/DC conversion stage and the second DC/DC conversion stage. Therefore, the storage system is charged downstream of the AC/DC and discharged by the DC/DC.

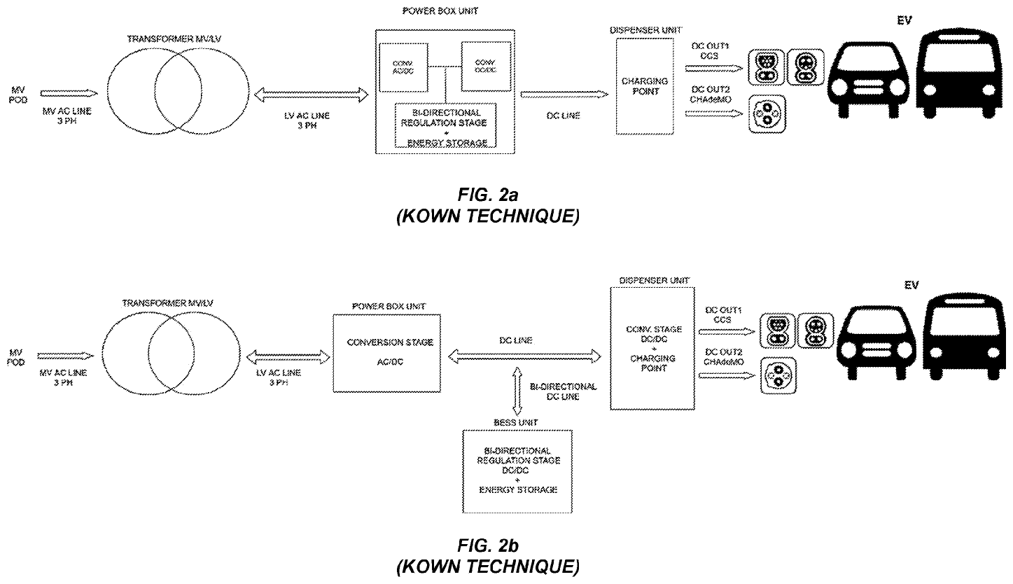

Two product categories can be of such typology, respectively schematized in FIGS. 2a and 2b.

More precisely, the diagram of FIG. 2a provides two main conversion sections within the same device (Power Box Unit), while the diagram in FIG. 2b provides main conversion sections in separate devices (AC/DC in the Power Box Unit and DC/DC in the Dispenser Unit).

In both cases mentioned, the BESS can be used to reduce connection costs, but also to manage power increases/peaks.

As in the previous case, however, in the configuration of FIG. 2a the power unit system must be previously designed to provide maximum power, without the possibility of being upgradeable in the future.

While in the configuration of FIG. 2b it is required that the DC/DC must be suitably designed considering the presence of the storage system.

In both cases mentioned of the combined architecture (FIGS. 2a and 2b), the BESS can be used to reduce connection costs, although once again the limitations seen in the case of Centralized Architecture would be incurred, also to manage increases/peaks of power.

In this case, however, the limitations incurred with this type of product/configuration are mainly related to a lack of flexibility towards new configurations. In fact, in the configuration of FIG. 2a the storage system cannot be separated from the remaining parts constituting the Power Box Unit, therefore the presence thereof must be defined in the design phase and there cannot be a retrofit in the field. In the configuration of FIG. 2b, the increase in power may be managed by retrofitting in terms of an increase in the number of Dispenser Units, and therefore of an increase in recharging points. On the other hand, the increase in power on the recharging points already present, whether not thought of during the development phase, cannot be implemented except with a retrofit having a significant impact on the Dispenser Unit (electronic DC/DC conversion which already proves to be challenging from the compactness point of view).

Furthermore, the presence of storage has a minor impact in terms of efficiency, as an additional conversion stage (however single with respect to the double stage of the Centralized Configuration) may not be provided.

It is therefore apparent that each of the configurations used to date has several technical limitations and disadvantages and that therefore the need is particularly felt for solutions which do not have these drawbacks and, on the contrary, produce improvement effects in terms of efficiency and flexibility of the charging system.

### Technical Problem Solved by the Invention

The object of the present invention is therefore to solve the problems left open by the known art, providing a charging system as defined in claim 1.

Further characteristics of the present invention are defined in the corresponding dependent claims.

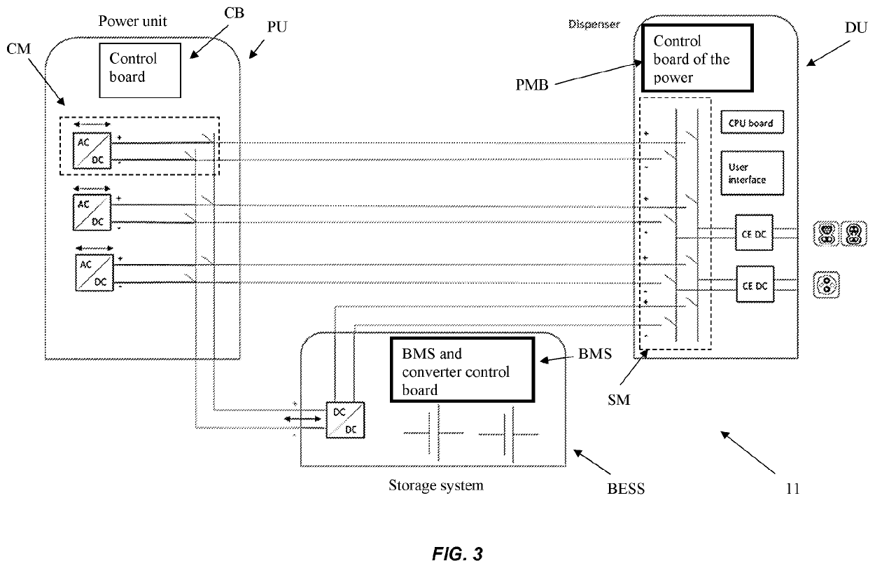

In general terms, a system according to the invention is schematized in the principle block diagram of FIG. 3.

Such a system aims to solve the limitations of the previous solutions by making the architecture very flexible, especially if taking into account the continuous technological developments relating to the batteries that involve a continuous increase in the power required by the individual vehicle during recharging and therefore request at the single charging point.

Precisely from this perspective, the new architecture is made very flexible as the charging station can be installed with the presence of the BESS from the beginning or even following a subsequent need to increase power on a single point.

The BESS will interface with the Power Box Unit as regards the charging functions, while for the power delivery it will interface directly with the Dispenser Unit. This will further cause a lower impact in terms of efficiency in this case, give that an additional conversion stage (in any case single compared to the double stage of the Centralized Configuration) may not be provided. In fact, only one conversion stage (internal to the BESS) is required in the centralized solution for recharging the storage tank, while for vehicle recharging (BESS discharge) there would be a series of at least two conversion stages. Instead in the invention by choosing the voltage value of the output bus consistent with the operating range of the battery pack, the BESS would only consist of a charge regulation system instead of an actual conversion stage. Thereby, there would be only one conversion stage in both charging chains, with a higher total system efficiency.

This, combined with a control section CS of the dispensing unit DU, allows the charging station to manage the recharge of one or more vehicles by distributing the power available only from the Power Box Unit or if present (and sufficiently charged) by the BESS, choosing the configuration suitable at the time of the request. Appropriate configuration means the best possible configuration evaluated based on the vehicle's power request by checking the state of charge of the BESS (to estimate the power usable by the storage) and the number and type of modules available (in terms of output power deliverable from the single module) (whether, for example, a recharge already active is further present and the subsequent vehicle will connect to the second dispenser of the Dispenser Unit).

In addition, through the Power Box Unit, the energy storage unit will further manage any network services (such as primary, secondary or tertiary regulation).

Thereby, the architecture is more flexible, upgradeable with retrofit of the pre-existent low-impact hardware and therefore better management of the continuous technological evolution occurring in the short term in the field of electric mobility.

In the final analysis, all the constraints relating to the previous solutions are no longer present and allow for a more versatile and configurable architecture based on the needs on the network side (reduction of operating costs relating to the connection which can be reduced by the BESS and by the dispatching services to the network) and the changing needs on the vehicle side (reduction of non-recurring costs relating to retrofits).

Other advantages, combined with the characteristics and methods of use of the present invention, will become apparent from the following detailed description of its preferred embodiments, presented by way of non-limiting example.

### DETAILED DESCRIPTION OF PREFERRED EMBODIMENTS

The present invention will be described below with reference to the figures above indicated.

In particular, FIG. 3 shows, by way of example, a principle block diagram of a first embodiment of a charging system 11 according to the invention.

The invention realizes a system 11 for high-power recharging for electric vehicles. This solution allows not to lose the benefits to users of high-power recharging, and in case of need, in order to reduce the impact on the network (reduction in connection costs and use of network dispatching services).

The charging system 11 comprises, fundamentally, a power unit PU (Power Box Unit) which, preferably, has an output power from 150 kW to 475 kW, more preferably of about 350 kW.

The power supply unit is the device that can convert alternating current (AC) into direct current (DC).

This unit, according to several embodiments of the invention, can provide a series/parallel configuration of AC/DC bidirectional sub-modules CM, responsible for the transformation from AC to DC and vice versa.

The modularity of the power part allows to manage the power towards the vehicle to be recharged in a more precise way, as well as in the event of a malfunction of one or more sub-modules, to continue providing the service with the sub-modules operating at reduced power.

For this reason, the power of a single AC/DC converter can range from 20 kW to 75 kW.

The output of such sub-modules is in DC, in a voltage range of 200-800 V or 600-1200 V. An input stage of a stage unit BESS can be connected to the DC bus, downstream of the AC/DC converters, which therefore may be recharged by the network when there are no vehicles being recharged, or in general, when the power required by the electric vehicle being recharged does not require maximum power.

Furthermore, thanks to the bi-directionality of the AC/DC module, it will be possible to make the storage system active in the market of electricity dispatching.

The different power sub-modules CM are managed by a control apparatus CB, typically an electronic board configured (according to hardware and/or software mode) to independently activate/deactivate each of the sub-modules CM.

In turn, the Dispensing unit DU comprises a control section CS which provides switching devices SM configured to activate/deactivate the connection of the dispensing unit DU with one or more of the sub-modules CM, and a power management board PMB configured to command the switching devices SM on the basis of voltage and current values required by vehicles being recharged.

For this purpose, the power management board PMB of the dispensing unit DU is further configured to communicate with the control apparatus CB of the power unit PU in order to communicate the required voltage and current values and set the voltage and current working points in output from the power unit while charging.

The stage unit BESS is advantageously equipped with an input stage provided with a bidirectional DC/DC converter, and an output stage connected to the dispensing unit DU via switching devices SM. The connection of the output stage of the stage unit BESS with the dispensing unit DU is activated/deactivated by the power management board PMB on the basis of the required voltage and current values from vehicles being recharged.

Furthermore, such board can communicate with an electronic management board of the storage system BMS, to activate the AC/DC modules required for its recharge.

According to several embodiments of the invention, the stage unit BESS can be provided with a minimum deliverable power of about 125 kW.

The stage unit can be charged from the DC bar in output by the AC/DC module while the output voltage is equal to the values required by the vehicle during recharge.

The management board of the storage battery BMS further manages the recharge for the individual cells which the storage system is composed thereof and communicates:
with the control board of the power unit PBM, for managing the charge of the storage system, and
with the control section CS installed in the Dispenser Unit to manage the discharge from the storage system towards the electric vehicle.

The capacity can be variable, ranging from 80 kWh and upward.

Advantageously, the BESS may be further provided to be modular rather than single, so as to have, as already for the power part, a power granularity which allows to manage any partial failures of the storage system.

Furthermore, according to the present invention, the Dispensing unit DU performs further different roles, among which:
Operating as an interface with the customer via a touchscreen display, multilingual system, enabling system for charging based on RFID, NFC, payment system, Bluetooth and WiFi;
Ensuring communication with the backend system, preferably based on 4G/5G with OCPP protocol (Open Charge Point Protocol) or other proprietary protocol;
Ensuring cooling of the high power cable;
Managing the output power from the unit.

The power management board PMB of the dispensing unit communicates with the control apparatus CB of the power unit, with the control board of the storage system converter, and with the vehicle being recharged via digital communication.

On the basis of values that the vehicle requires for current and voltage, and therefore power, the power management board:
Communicates with the control board of the power unit to provide the required voltage and current;
Communicates with the control board of the converter to manage the storage system;
Activates the switching devices SM to enable or disable several power modules and/or the storage system.

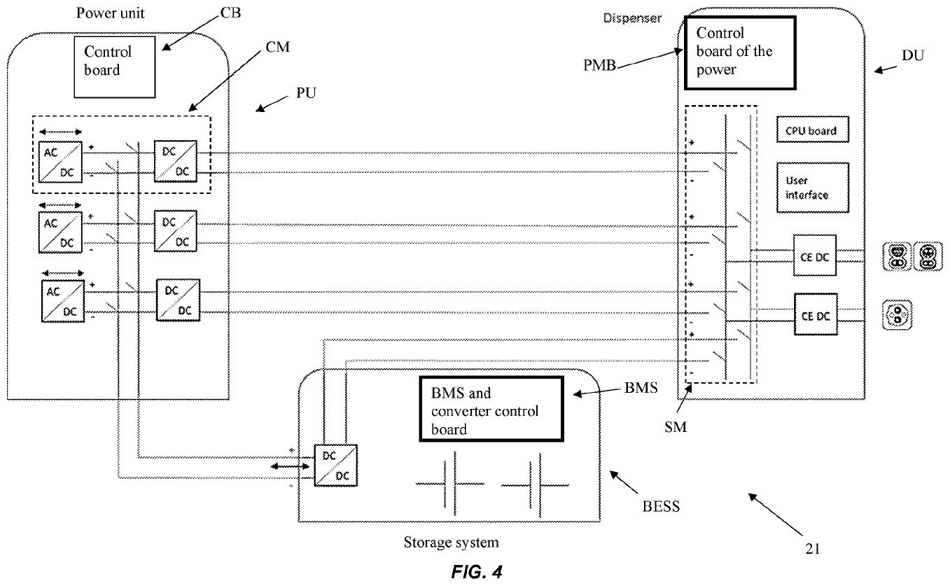

The subsequent FIG. 4 shows, by way of example, a second embodiment of a system according to the invention.

In particular, according to this embodiment, a system 21 provides each of the power sub-modules CM) to further comprise a DC/DC converter, responsible for bringing the DC voltage to values consistent with those useful for recharging a vehicle, and therefore from 200 V to 1500 V in DC, connected downstream of the respective AC/DC converter.

Also the DC/DC converter can operate preferably in a power range from 20 to 75 kW.

As for the AC/DC sub-module, the same benefits and advantages of having smaller DC/DC power sub-modules apply.

According to this embodiment, the input stage of the energy storage unit BESS is connected between the AC/DC converters and the DC/DC converters of the power unit PU.

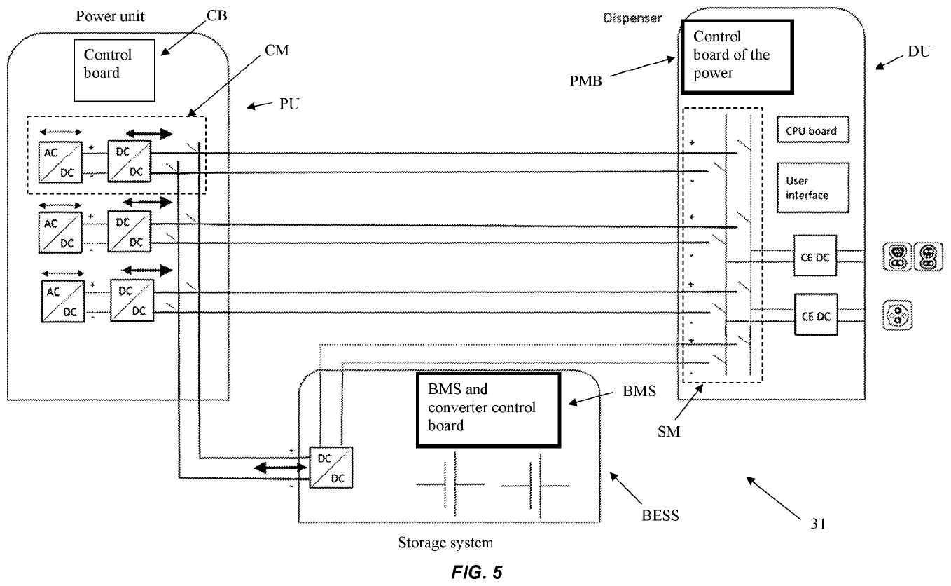

The following FIG. 5 shows, by way of example, a third embodiment of a system according to the invention, which differs from the first one due to the conversion in the power unit being carried out by two separate stages AC/DC and DC/DC, and from the second embodiment due to the input stage of the energy storage unit BESS being connected downstream of the DC/DC converters of the power unit PU.

To ensure the performance of network services, the DC/DC converters of the power unit PU are preferably of the bidirectional type.

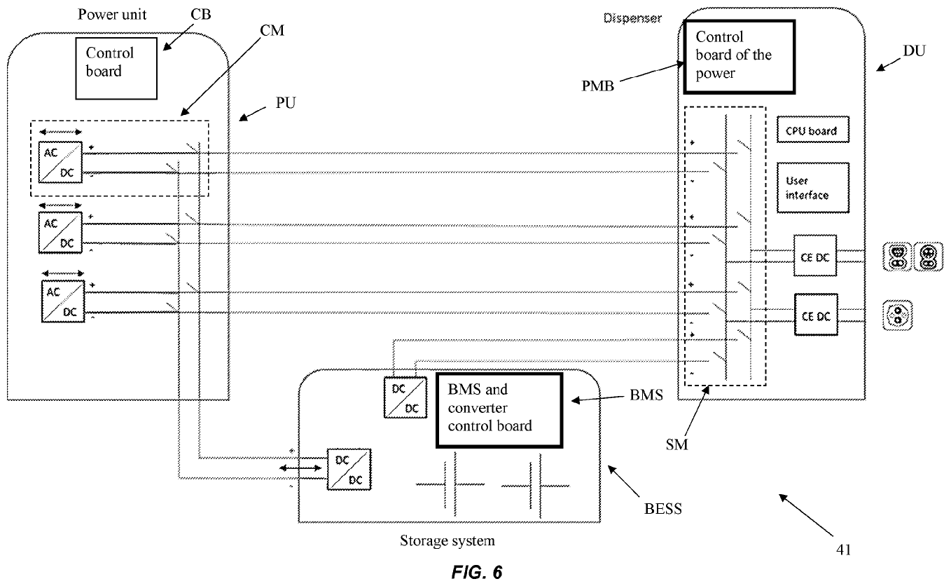

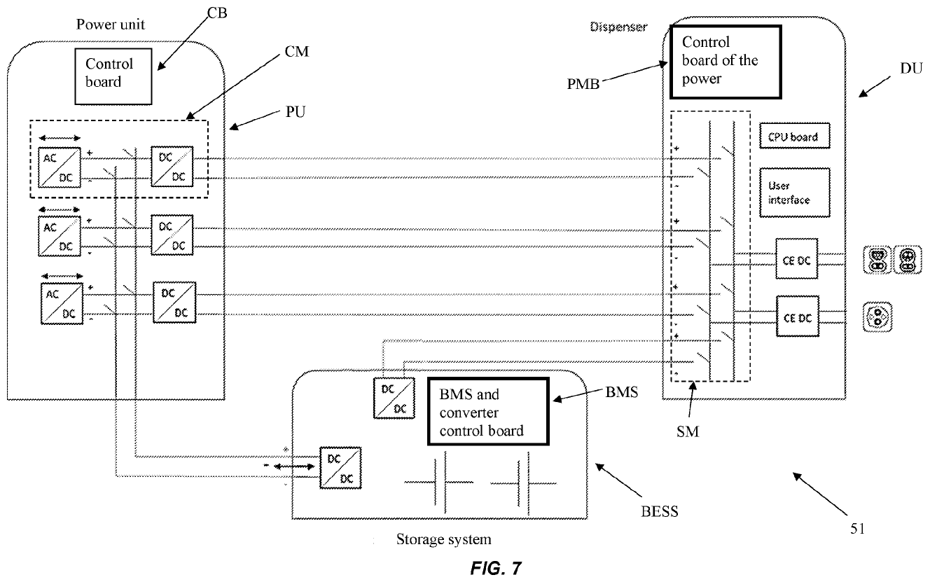

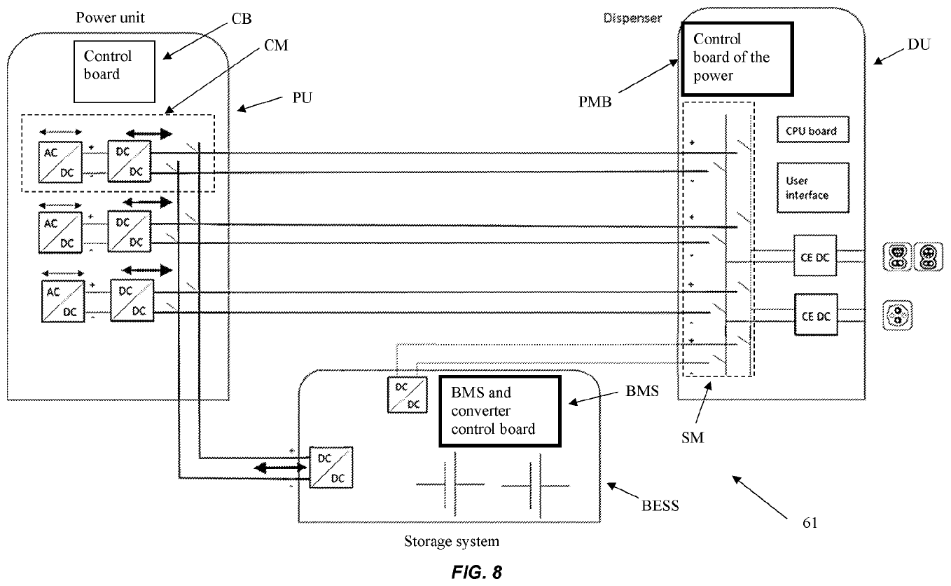

The following FIGS. 6 to 8 respectively schematize a fourth, fifth and sixth embodiment of system according to the invention, corresponding respectively to the first, second and third embodiment hitherto described, with the difference that these provide the output stage of the energy storage unit BESS to comprise an additional unidirectional DC/DC converter to supply power to the dispensing unit DU.

It is understandable that these embodiments allow to specialize the realization of the two DC/DC converters of the stage unit, one dedicated to recharge and services to the network and the other dedicated to discharge, i.e. to the supply of energy to the vehicles to be recharged, with a resultant constructive simplification of such devices.

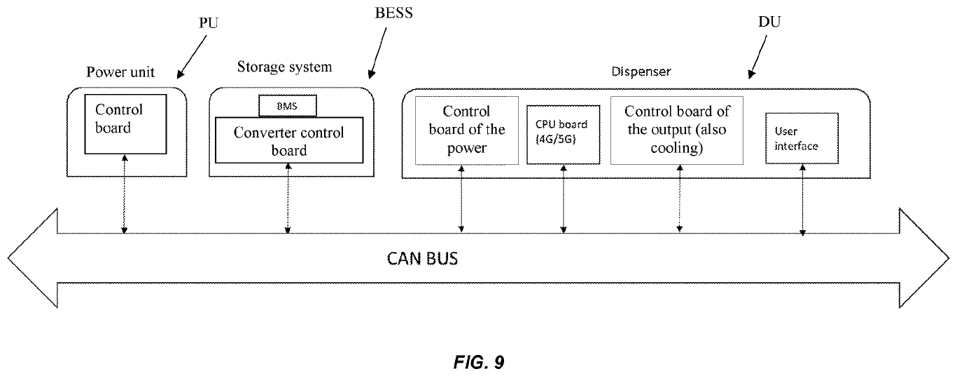

FIG. 9 schematizes the communication between the various boards, which are therefore preferably based on CAN bus, or can be based on RS485 or other.

Substantially, it is emphasised that the architecture of the recharging system of the invention is based on a flexible, modular solution, in which each component (power unit, dispensing unit, energy storage unit BESS) can be updated/replaced individually without affecting others.

For example, when more output power is required, it is possible to:
add the unit BESS if not initially supplied;
upgrade the unit BESS with a larger battery capacity;
update the power unit by adding additional power sub-modules CM, without modifying what is already present;
add another power unit in addition to the one already present.

In addition, the proposed architecture can ensure greater overall system efficiency during recharge electric vehicles, considering the discharge of the Unit BESS.

According to a preferred aspect of the invention wherein the unit BESS is directly connected to the dispensing unit (DU), a particularly flexible architecture is achieved, in which the power unit (PU) is the device connected to the network AC capable of converting AC power to DC power in order to supply power to:
the dispensing unit when recharging the electric vehicle;
the unit BESS during recharge the battery;
the Grid network (from BESS and EV) during the operation of the energy services.

It is specified that the dispensing unit houses the switching matrix and the incoming of all the power lines from each DC/DC of the power supply unit and the BESS. By moving the switching matrix to dispensing, DC/DC management is required from dispensing, and management is in terms of voltage and current. Since all the DC/DC converters present in the power unit and in the BESS are arranged in parallel, they can supply the same voltage level (based on the EV recharge request).

It means that if an electric vehicle requires a voltage level during recharge, for example 250 A, the 250 A can be drawn from different DC/DC converters (based on the power connections of the Grid network and the recharging state of the unit BESS). Thereby, during recharge the DC/DC converters can be activated or to deactivated according to the voltage/current values required by the electric vehicle and the BESS can be disconnected when the recharging state is below a predetermined level.

The role of the switching matrix is to connect or disconnect the DC/DC converter present in the power unit and in the unit BESS, fulfilling the needs of the vehicle during recharge. In addition, the proposed architecture allows that new DC/DC may be directly connected to the dispenser, without operating on the additional components.

For example, in an embodiment of the comprising system with 4 DC/DC converters present in the power unit and N.1 DC/DC in the BESS, with the following details:

TABLE 1

| | | | Output DC | Max output | Maximum current | Maximum current |
|---|---|---|---|---|---|---|
| | | Power | voltage range | DC current | per voltage | per maximum |
| DC/DC | Presence | (kW) | (V) | (A) | level | voltage |
| 1 | Power unit | 90 | 200-1000 | 200 | 200 A-400 V | 100 A-900 V |
| 2 | Power unit | 90 | 200-1000 | 150 | 150 A-400 V | 100 A-900 V |
| 3 | Power unit | 50 | 100-500 | 125 | 125 A-400 V | 125 A-400 V |
| 4 | Power unit | 40 | 100-500 | 100 | 100 A-400 V | 100 A-400 V |
| 5 | BESS | 135 | 200-1000 | 200 | 200 A-400 V | 150 A-900 V |

Hereafter several examples related to the previous Table 1, when an electric vehicle is connected to the dispensing and assuming that the SoC of the BESS is at 100%, and a voltage is requested to be:
900 V: the switching matrix can receive power from DC/DC number 1, 2 and 5, and not from 3 and 4;
400 V: the switching matrix can receive power from all DC/DC.

The present invention has been hitherto described with reference to its preferred embodiments. It should to be understood that each of the technical solutions implemented in the preferred embodiments, herein described by way of example, may be advantageously combined, in a different way from what is described, to the others, to give shape to further embodiments, which pertain to the same inventive core and in any case each belonging to the protection scope of the claims set forth below.

1. High-power charging system for electric vehicles with energy storage unit including:
a power unit that can be connected to an electricity supply network; and
a dispensing unit to provide electricity to the vehicles to be recharged, wherein said power unit comprises a plurality of power sub-modules in series/parallel configuration, each comprising a bidirectional AC/DC converter and a control apparatus configured to independently activate/deactivate each one of said one or more sub-modules,
wherein said dispensing unit comprises a control section which provides switching devices configured to activate/deactivate the connection of the dispensing unit with one or more of said sub-modules, and a power management board configured to control said switching devices on the basis of voltage and current values required by the vehicles being recharged,
said power management board being also configured to communicate with the control apparatus of the power unit to communicate the required voltage and current values; the charging system further comprising an energy storage unit, comprising an input stage connected downstream of said AC/DC converters of the power unit and equipped with a bidirectional DC/DC converter, and an output stage connected to said dispensing unit through said switching devices, the connection of the output stage of the storage unit with the unit dispensing system being activated/deactivated by said power management board on the basis of the voltage and current values required by the vehicles being recharged,
wherein each of said power sub-modules comprises a DC/DC converter, connected downstream of the respective AC/DC converter.

2. Charging system according to claim 1, wherein the input stage of the energy storage unit is connected to said AC/DC converters and said DC/DC converters of the power unit.

3. Charging system according to claim 1, wherein said DC/DC converters of the power unit are of the bidirectional type and the input stage of the energy storage unit is connected downstream of said DC/DC converters of the power unit.

4. Charging system according to claim 1, wherein the output stage of said energy storage unit comprises a further unidirectional DC/DC converter.

5. Charging system according to claim 1, wherein said power unit has an output power ranging from 150 kW to 475 kW, preferably of about 350 kW.

6. Charging system according to claim 1, wherein each AC/DC converter of the power unit has an output power ranging from 20 kW to 75 kW.

7. Charging system according to claim 1, wherein each AC/DC converter of the power unit has a direct output voltage ranging from 200 V to 1200 V.

8. Charging system according to claim 1, wherein each DC/DC converter of the power unit has a direct output voltage ranging from 200 V to 1500 V.

9. Charging system according to claim 1, wherein each DC/DC converter of the power unit has an output power ranging from 20 kW to 75 kW.

10. Charging system according to claim 1, wherein the storage unit has a minimum deliverable power of about 125 kW and a continuous output voltage ranging from 200 V to 1500 V.

11. Charging system according to claim 1, wherein the storage unit is made according to a modular architecture, presenting two or more storage sub-units that can be selectively and independently managed.

12. Charging system according to claim 1, wherein said dispensing unit comprises:
a user interface;
an enabling charging and payment system based on RFID, NFC, Bluetooth and/or WiFi;
communication equipment with a backend system, preferably based on 4G/5G with OCPP protocol or other proprietary protocol.

13. Charging system according to claim 1, wherein the communication between the devices is based on CAN bus.
